(19) United States
(12) Patent Application Publication
(10) Pub. No.: US 2026/0228072 A1
(43) Pub. Date: Aug. 6, 2026

(54) PRACTICAL BYZANTINE FAULT TOLERANCE ("PBFT") ENABLED INTELLIGENT CONTAINER ORCHESTRATION ("ICO") ENGINE

(71) Applicant: Bank of America Corporation, Charlotte, NC (US)

(72) Inventors: Vinod Maghnani, Gurugram Haryana (IN); Vinod Krishnan, Chennai Tamil Nadu (IN)

(21) Appl. No.: 19/047,030

(22) Filed: Feb. 6, 2025

(51) Int. Cl. G06F 11/07; G06F 9/455

(52) U.S. Cl. CPC G06F 11/0709; G06F 9/455; G06F 11/0772; G06F 11/0793; G06F 2009/45595

(57) ABSTRACT

Apparatus, methods and systems for identifying and solving interruptions occurring within orchestration scripts. The methods may include identifying an interruption at an observer engine. The methods may include pausing execution of the orchestration script. The methods may include analyzing, at the decision engine, whether to determine a solution to the interruption via a cloud computing resolution system or via artificial intelligence (“AI”)/machine learning (“ML”). The decision engine may execute a practical byzantine fault tolerance (“pBFT”) algorithm configured to determine an output based on a majority consensus from a group of nodes. In response to reaching a majority consensus to resolve the interruption via the cloud computing resolution, resolving the interruption via a cloud computing solution. In response to reaching a majority consensus to resolve the interruption via AI/ML, resolving the interruption via an AI/ML solution. The methods may include resuming the orchestration script.

### FIELD OF TECHNOLOGY

Aspects of the disclosure relate to cloud computing, practical byzantine fault tolerance (“pBFT”) algorithms and artificial intelligence (“AI”).

### BACKGROUND OF THE DISCLOSURE

In a cloud environment, DevOps cloud engineers generally use container platforms and tools to automate orchestration processes. The orchestration processes are usually automated using different orchestration scripts, such as, yet another markup language (“YAML”) or JavaScript™ object notation (“JSON”) files. The different orchestration scripts are used for infrastructure management, configuration, deployment, scalability, resiliency, monitoring, logging, load balancing/performance and any other orchestration process.

When executing such orchestration scripts, interruptions may occur. The interruptions may be caused by incorrect sizing of clusters, nodes or pods included in a given cloud computing system. The interruptions may also be caused by an imbalance in resource allocation between different components of the cloud computing system. The interruptions may also be caused by a lack of memory space within the cloud computing system. The interruptions may also be caused by central processing unit (“CPU”) throttling. The interruptions may also be caused by increased latency within the different components of the cloud computing system. The interruptions may also be caused by inefficiencies within the different components of the cloud computing system. The interruptions may also be caused by any other bottlenecks that occur within the different components of the cloud computing system.

Current automation tools, conventionally the execution of an orchestration script, are unable to resume an orchestration process from a point of an interruption. As such, current automation tools require restarting from an initial starting point upon an occurrence of an interruption. Restarting an orchestration process, from an initial starting point, after an interruption, can lead to redundancy, latency and wasted resources.

Therefore, it would be desirable to provide a self-learning system that is configured to resolve multiple interruption types and resume the execution of orchestration scripts from the point of the interruption.

### SUMMARY OF THE DISCLOSURE

Systems, apparatus and methods for identifying interruptions occurring within orchestration scripts are provided. The orchestration scripts may be executing. The orchestration scripts may be executing to deploy containers in a cloud computing platform. Systems, apparatus and methods may further include determining solutions for the identified interruptions.

The methods may include using an intelligent container orchestration (“ICO”) engine.

The ICO engine may monitor a cloud computing platform. The cloud computing platform may include any suitable cloud computing components. The cloud computing platform may include a cloud computing platform orchestration tool. The cloud computing platform orchestration tool may execute different scripts. The different scripts may be used to automatically manage applications in a cloud computing platform. The applications may perform tasks, such as node provisioning, resource deployment and scaling, networking, load balancing, and/or any other suitable cloud computing platform application. The orchestration tool may be used to reduce manual intervention and improve operational efficiency within the cloud computing platform.

The methods may include using an ICO engine to monitor a cloud computing platform automation tool. Cloud computing platform automation tools may include yet another markup language (“YAML”), JavaScript™ object notation (“JSON”) files or any other suitable cloud computing automation tools.

The ICO engine may include hardware components, such as one or more processors, one or more nodes, one or more power sources, one or more memory locations, one or more displays, one or more wires/data cables or any other suitable hardware computing components. The ICO engine may include software components, such as firmware, logic, application programs, algorithms, protocols, one or more graphical user interfaces and/or any other suitable software components.

The ICO engine may include an observer engine. The ICO engine may include a decision engine. The ICO engine may include a learner engine. The ICO engine may include an intelligence base. The ICO engine may include an apply input engine. The ICO engine may include a resumption log. The ICO engine may include a resumption analyzer engine. The ICO engine may include any other suitable engine. The observer engine, decision engine, learner engine, intelligence base, apply input engine, resumption log, resumption analyzer engine and any other suitable engine may include any hardware or software components included in the ICO engine.

The methods may include identifying an interruption at the observer engine. The interruption may occur within an orchestration script. The observer engine may monitor the orchestration script, as the orchestration script is being executed. The observer engine may monitor logs of the orchestration script, as the orchestration script is being executed. The identifying may include capturing a screen recording/screen capture of the orchestration script. The identifying may include capturing a screen recording/screen capture of the logs of the orchestration script. The observer engine may detect, from the screen recording/screen capture, a point of interruption within the orchestration script.

The point of interruption may include an identification of an orchestration script name. The point of interruption may include an identification of a line number in which the interruption is identified. The point of interruption may include an identification of a date and time when the interruption occurred. The point of interruption may include any suitable data relating to the identified interruption.

The observer engine may generate an observation output. The observation output may include data relating to the point of interruption.

In response to identifying the interruption, the methods may include pausing execution of the orchestration script. The pausing of the execution script may temporarily pause the execution of the automation being executed by the orchestration script.

The observer engine may transmit the observation output to the decision engine. The decision engine may execute a practical byzantine fault tolerance (“pBFT”) algorithm. The pBFT algorithm configured to determine an output based on a majority consensus from a group of decisioning nodes. The group of decisioning nodes may be included in the ICO.

The pBFT algorithm may be leveraged to enable the ICO engine to achieve a majority consensus despite potential malicious decisioning nodes propagating incorrect or false information. The pBFT algorithm may be used to mitigate the influence that the malicious decisioning nodes affect the consensus protocol.

The pBFT algorithm may designate a decisioning node as a designated primary node. The designated primary node may propose a request by transmitting the request to other decisioning nodes included in the cloud computing system. Each decisioning node may reach a consensus to the request through a series of consensus rounds. The series of consensus rounds may ensure an agreement even if some of the decisioning nodes are malicious. The consensus rounds may include a plurality of phases, where a majority consensus is received in order to progress to the next phase. The multiple phases and majority consensus may allow for reliable decision-making in a distributed system despite potential malicious decisioning nodes.

The methods may include analyzing, at the decision engine, whether to determine a solution to the interruption via a cloud computing resolution system or via artificial intelligence (“AI”)/machine learning (“ML”).

Solutions to the interruption may include resizing nodes/clusters of cloud computing components. Solutions may include reallocating resources between different cloud computing components. Solutions may include freeing up/adding more memory space. Solutions may include solving inefficiencies/latencies between the different cloud computing components. Solutions may include any suitable solution to solve the interruption.

In response to reaching a majority consensus from the group of decisioning nodes included in the ICO to resolve the interruption via the cloud computing resolution, the methods may include resolving the interruption via a cloud computing solution. The resolving may include electronically transmitting the observation output to the cloud computing resolution system. The cloud computing resolution system may include human intervention. The cloud computing resolution system may be operated by a cloud computing expert. The cloud computing resolution system may be operated by a DevOps expert. The cloud computing resolution system may not include human intervention. The cloud computing resolution system may be a logic-based system. The cloud computing system may be a rule-based system. The cloud computing system may be any suitable resolution system configured to resolve identified interruptions.

The cloud computing expert may analyze the details relating to the point of interruption included in the observation and output and determine a solution for the interruption. The rule-based system may analyze the details relating to the point of interruption included in the observation and output and determine a solution for the interruption. The solution may be a cloud computing solution.

The cloud computing resolution system may transmit the cloud computing solution to the ICO engine. The ICO engine may electronically receive the cloud computing solution from the cloud computing resolution system.

In response to receiving the cloud computing solution, the methods may include implementing the cloud computing solution with the orchestration script. Implementing the solution may include revising lines of the orchestration script and running the revised orchestration script to execute the solution. Implementing the solution may include rewriting the orchestration script and running the rewritten orchestration script to execute the solution. Implementing the solution may include writing a new orchestration script and running the new orchestration script to execute the solution. Implementing the solution may include any other suitable implementation.

After implementing the cloud computing solution, the methods may include using the point of interruption to identify where the interruption occurred in the orchestration script. Based on the identification the location of the occurrence of the interruption, the methods may include resuming the orchestration script at the point of interruption.

In parallel with implementation of the cloud computing solution to the orchestration script, the methods may include transmitting the cloud computing solution to the learner engine. The learner engine may generate an analysis of the cloud computing solution and store the analysis in the intelligence base.

The methods may include storing the interruption and the cloud computing solution in the resumption log. The resumption log may include a listing of all identified interruptions and implemented solutions for the orchestration script.

In response to reaching a majority consensus from the group of decisioning nodes included in the ICO to resolve the interruption via AI/ML, the methods may include resolving the interruption via an AI/ML solution. The resolving may include transmitting the observation output to an apply input engine. The apply input engine may be in electronic communication with an AI/ML engine.

The AI/ML engine may include progressive learning algorithms. The progressive learning algorithms may ingest training data. The progressive learning algorithms may analyze the ingested training data. The progressive learning algorithms may analyze the training data for correlations and patterns within the data. The progressive learning algorithms may use the analyzed correlations and patterns to generate outputs. The AI engine may update the progressive learning algorithms based on the generated outputs curated/retrieved from the analyzed correlations and patterns.

The AI/ML engine may include machine learning algorithms. Machine learning algorithms may enable the AI/ML engine to learn from experience without specific instructional programming. The AI/ML engine may include deep learning algorithms. Deep learning algorithms may utilize neural networks. Neural networks may use interconnected nodes or neurons in a layered structure to analyze data and generate outputs.

The apply input engine may generate the AI/ML solution using data and analyses stored in the intelligence base. The data and analyses may be used to train the AI/ML engine. The apply input engine may generate the AI/ML solution based on historical interruptions and successful corresponding solutions stored in the intelligence base and the resumption log.

The methods may include implementing the AI/ML solution to the orchestration script. After implementing the AI/ML solution to the orchestration script, the methods may include using the point of interruption to identify where the interruption occurred in the orchestration script. Based on the identification of where the interruption occurred, the methods may include resuming the orchestration script at the point of interruption. The methods may include storing the interruption and the AI/ML solution in the resumption log.

The methods may include continually training the ICO engine using the intelligence base, the resumption log and the AI/ML engine. The methods may include continually training the ICO engine in order to continually update data being ingested by the ICO engine and the AI/ML engine to enhance decision-making and predictive outputs being generated by the ICO engine and the AI/ML engine.

As the ICO engine is continually trained, the ICO may be able to resolve more interruptions via AI/ML than via the cloud computing system. The more the ICO engine is trained the more accurate and precise the AI/ML generated solutions may be.

The methods may include using the ICO to continually identify interruptions during execution of the orchestration script. As long as the orchestration script is executing, the ICO engine may monitor the orchestration script, identify interruptions and resolve the identified interruptions. The ICO may continually identify interruptions as long as one or more orchestration script are being executed within the cloud computing platform.

The methods may include looping through the resumption log to identify duplicate interruptions and corresponding solutions. The resumption log may store a plurality of interruptions and corresponding solutions over a period of time. The interruptions and corresponding solutions may be from one orchestration script. The interruptions and corresponding solutions may be from a plurality of orchestration scripts.

The methods may include assigning a rank to each interruption and corresponding solution based on a frequency of occurrence for each interruption and corresponding solution. For example, a first interruption resolved by a first solution may have occurred twice. In response to identifying that the first interruption resolved by the first solution occurred twice, the first interruption and first solution may be ranked with a first ranking. A second interruption resolved by a second solution may have occurred six times. In response to identifying that the second interruption resolved by the second solution occurred six times, the second interruption and second solution may be ranked with a second ranking. A third interruption resolved by a third solution may have occurred once. In response to identifying that the third interruption resolved by the third solution occurred once, the third interruption and third solution may be ranked with a third ranking. A ranking representing a greater frequency of occurrence may be greater in numeric value than a ranking representing a lesser frequency of occurrence. A greater ranking may indicate a greater frequency of occurrence. A lesser ranking may indicate a lesser frequency of occurrence. The second ranking may therefore be a greater ranking than the first ranking. The first ranking may therefore be a greater ranking than the third ranking.

After assigning a rank, the methods may include deleting the duplicate interruptions and corresponding solutions. After the duplicate interruptions and corresponding solutions are deleted, the resumption log may list each individual interruption and corresponding solution and a frequency of occurrence for each interruption and corresponding solution.

The methods may include weighing each interruption and corresponding solution. Weighing each interruption and corresponding solution may determine a level of influence for each interruption and corresponding solution when the interruptions and corresponding solutions are used to train the ICO engine and the AI/ML engine. An interruption and corresponding solution with a weight that is greater than a threshold weight may have a greater influence on the training of the ICO engine and the AI/ML engine. An interruption and corresponding solution with a weight that is less than the threshold weight may have a lesser influence on the training of the ICO engine and the AI/ML engine.

Each interruption and corresponding solution may be weighed based on the rank assigned to each interruption and corresponding solution. For example, an interruption and corresponding solution that was assigned a higher ranking (i.e. has a greater frequency of occurrence), may be weighed with a greater weight. An interruption and corresponding solution that was assigned a lower ranking (i.e. has a lesser frequency of occurrence) may be weighed with a lesser weight.

Each interruption and corresponding solution may be weighed based on whether or not the corresponding solution was successful for each interruption. For example, a corresponding solution for an interruption that was determined to be successful over a threshold level of success may be weighed with a greater weight. A corresponding solution for an interruption that was determined to be successful under a threshold level of success may be weighed with a lesser weight.

The methods may include training the ICO engine using the weighed interruptions and corresponding solutions. Weighing the interruptions and corresponding solutions may enable more accurate and precise decision making and prediction generation.

The methods may include honing the apply input engine based on an effectiveness of a corresponding solution for resolving an interruption. Honing the apply input engine may include improving the accuracy and precision of outputs generated by the apply input engine. Honing the apply input engine may include continually updating and improving the apply input engine. In response to determining an effectiveness of a corresponding solution for resolving an interruption, the methods may include using the interruption and corresponding solution to further train the apply input engine.

The methods may include honing the pBFT algorithm based on an effectiveness of a corresponding solution for resolving an interruption. Honing the pBFT algorithm may include improving the accuracy and precision of the decision-making being executed by the pBFT algorithm. Honing the pBFT algorithm may include continually updating and improving the pBFT algorithm. In response to determining an effectiveness of a corresponding solution for resolving an interruption, the methods may include using the interruption and corresponding solution to further train the pBFT algorithm.

The methods may include using the resumption analyzer engine to generate an intelligence trend. The intelligence trend may identify a pattern of which interruptions occur at level of frequency that is greater than a threshold frequency and which interruptions occur at a level of frequency that is less than a threshold level of frequency. The intelligence trend may be stored in the intelligence base. The intelligence trend may be continually updated. The intelligence trend may be used to train the ICO engine and the AI/ML engine.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout and in which:

FIG. 1 shows an illustrative diagram in accordance with principles of the disclosure;

FIG. 2 shows another illustrative diagram in accordance with principles of the disclosure;

FIG. 3 shows an illustrative flow chart in accordance with principles of the disclosure;

FIG. 4 shows another illustrative flow chart in accordance with principles of the disclosure;

FIG. 5 shows another illustrative diagram in accordance with principles of the disclosure; and

FIG. 6 shows yet another illustrative diagram in accordance with principles of the disclosure.

### DETAILED DESCRIPTION OF THE DISCLOSURE

Systems, apparatus and methods for identifying interruptions occurring within orchestration scripts are provided. The orchestration scripts may be executing. The orchestration scripts may be executing to deploy containers in a cloud computing platform. Systems, apparatus and methods may further include determining solutions for the identified interruptions.

The apparatus may include an intelligent container orchestration (“ICO”) engine. The ICO engine may include hardware components, such as one or more a processor, user interface, power source, wires, cables and/or any other suitable computing device hardware. The ICO engine may include software components, such as software applications, firmware, algorithms and/or any other suitable software components the ICO engine comprising: The ICO engine may include a combination of hardware and software components. The ICO engine may only include software components.

The ICO may monitor a cloud computing platform. The cloud computing platform may include networking hardware, servers, cloud computing software, storage/memory locations and any other suitable cloud computing components. The cloud computing platform may include a cloud computing platform orchestration tool. The cloud computing platform orchestration tool may execute different scripts. The different scripts may be used to automatically manage applications in a cloud computing platform. The applications may perform tasks like node provisioning, resource deployment and scaling, networking, load balancing, and/or any other suitable cloud computing platform application. The orchestration tool may be used to reduce manual intervention and improve operational efficiency within the cloud computing platform.

The ICO engine may monitor a cloud computing platform automation tool. Cloud computing platform automation tools may include yet another markup language (“YAML”), JavaScript™ object notation (“JSON”) files or any other suitable cloud computing automation tools.

The ICO engine may execute artificial intelligence (“AI”)/machine learning (“ML”) algorithms. The AI algorithms may include progressive learning algorithms. The progressive learning algorithms may ingest training data. The progressive learning algorithms may analyze the ingested training data. The progressive learning algorithms may analyze the training data for correlations and patterns within the data. The progressive learning algorithms may use the analyzed correlations and patterns to generate outputs. The AI algorithms may update the progressive learning algorithms based on the generated outputs curated/retrieved from the analyzed correlations and patterns.

The ML algorithms may enable the ICO engine to learn from experience without specific instructional programming. The ML engine may include deep learning algorithms. Deep learning algorithms may utilize neural networks. Neural networks may use interconnected nodes or neurons in a layered structure to analyze data and generate outputs.

The ICO engine may include an observer engine. The observer engine may include hardware components, such as a processor. The observer engine may include software components, such as one or more application code elements and one or more algorithms. The observer engine may identify an interruption occurring within an orchestration script. The observer engine may capture a screen recording of the orchestration script. The observer engine may detect, from the screen recording, a point of interruption within the orchestration script.

The observer engine may identify an orchestration script name. The observer engine may identify a line number within the orchestration script at which the interruption was identified. The observer engine may identify a date and time when the interruption occurred. The observer engine may generate an observation output. The observation output may include data relating to the point of interruption identified by the observer engine. Data relating to the point of interruption may include, the orchestration script name, the line number in which the interruption was identified, the date and time when the interruption occurred and any other suitable data relating to the interruption.

The ICO engine may include an intelligence base. The intelligence base may include a memory. The memory may include random-access memory (“RAM”), read-only memory (“ROM”), cache, hard disk, databases, flash memory, erasable programmable memory (“EPROM”), electrically erasable programable memory (“EEPROM”) and/or any other suitable memory. The intelligence base may be configured to store the screen recording of the orchestration script.

The ICO engine may include an orchestration script pause engine. The ICO engine may be in electronic communication with the observer engine. The orchestration script pause engine may include executable software scripts. The executable software scripts may pause execution of the orchestration script. The executable software scripts may pause execution of the orchestration script in response to identification of an interruption by the observer engine.

The ICO engine may include a decision engine. The decision engine may be in electronic communication with the observer engine. The decision engine may include a plurality of decisioning nodes. The plurality of decisioning nodes may include computing device hardware, such as processors, memory, power sources, etc. The plurality of decisioning nodes may include virtual nodes, including computing software, such as algorithms, firmware and software applications. The plurality of decisioning nodes may be included in a network. The plurality of decisioning nodes may be in electronic communication with other decisioning nodes included in the plurality of decisioning nodes. The plurality of decisioning nodes may execute the AI/ML algorithms. The plurality of decisioning nodes may be trained with data stored in the intelligence base.

The decision engine may execute a practical byzantine fault tolerance (“pBFT”) algorithm. The pBFT algorithm may determine an output based on a majority consensus from the plurality of decisioning nodes. The pBFT algorithm may determine an output based on the majority consensus despite potential malicious decisioning nodes propagating incorrect or false information. The pBFT algorithm may be used to mitigate the influence that the malicious decisioning nodes have on the consensus protocol.

The pBFT algorithm may designate a decisioning node from the plurality of decisioning nodes as a designated primary node. The designated primary node may propose a request by transmitting the request to other decisioning nodes included in the plurality of decisioning nodes. Each decisioning node may reach a consensus to the request through a series of consensus rounds. The series of consensus rounds may ensure an agreement even if a portion of the decisioning nodes are malicious. The consensus rounds may include a plurality of phases, where a majority consensus is needed in order to progress to the next phase. The multiple phases and majority consensus may allow for reliable decision-making in a distributed system despite potential malicious decisioning nodes.

The decision engine may be in electronic communication with the observer engine. The decision engine may receive the observation output from the observer engine. The decision engine may receive the observation output from the observer engine in response to a pausing of the orchestration script by the orchestration script pause engine.

The decision engine may determine, using the decisioning nodes, whether to generate a solution to the interruption via a cloud computing resolution system or via artificial intelligence (“AI”)/machine learning (“ML”).

The cloud computing system may include an interface to correspond with a cloud computing (e.g. Development Operations) expert. The cloud computing expert may be a human expert. The cloud computing expert may be a virtual expert. In response to a majority consensus from the decisioning nodes to generate solution to the interruption via the cloud computing system, the observation output may be transmitted to the cloud computing interface. In response to receiving the observation output, the cloud computing expert may generate a cloud computing solution to resolve the interruption. The cloud computing solution may include rewriting the orchestration script, reallocation of computing resources, rerouting computing power and/or any other suitable solution.

The ICO engine may include a learner engine. The learner engine may execute the AI/ML algorithms. The learner engine may include hardware components, such as a processor. The learner engine may include software components, such as one or more application code elements and one or more algorithms. The learner engine may generate an analysis of the interruption and the cloud computing solution. The learner engine may store the analysis in the intelligence base. The analysis may be used to train the ICO engine and the AI/ML algorithms.

The ICO engine may include a resumption log. The resumption log may be stored at a centralized location within the cloud computing system. The resumption log may execute a plurality of scripts/code. After the ICO implements the cloud computing solution in the orchestration script, the resumption log may store the interruption and the cloud computing solution as an entry in the resumption log. The resumption log may include a status indicator. The status indicator may indicate whether the solution resolved the interruption. For example, a status indicator of “yes” may indicate that the solution resolved the interruption and status indicator of “no” may indicate that solution did not resolve the interruption. The status indicator may include any suitable combination of characters, numbers and/symbols.

The ICO engine may include an apply input engine. The apply input engine may execute the AI/ML algorithms. The apply input engine may include hardware components, such as a processor. The apply input engine may include software components, such as one or more application code elements and one or more algorithms. In response to a majority consensus from the decisioning nodes to generate solution to the interruption using AI/ML, the apply input engine may generate an AI/ML solution. The apply input engine may use data and analyses stored in the intelligence base to generate the AI/ML generated solution. The AI/ML algorithm may learn from the stored interruptions, solutions and success outcomes for each solution in order to generate the AI/ML generated solution. The AI/ML generated solution may include rewriting the orchestration script, reallocation of computing resources, rerouting computing power and/or any other suitable solution.

After the ICO implements the AI/ML generated solution in the orchestration script, the resumption log may store the interruption and the AI/ML generated solution as an entry in the resumption log. The resumption log may include a status indicator. The status indicator may indicate whether the solution resolved the interruption.

Implementing the cloud computing solution or the AI/ML generated solution may include revising lines of the orchestration script and running the revised orchestration script to execute the solution. Implementing the cloud computing solution or the AI/ML generated solution may include rewriting the orchestration script and running the rewritten orchestration script to execute the solution. Implementing the cloud computing solution or the AI/ML generated solution may include writing a new orchestration script and running the new orchestration script to execute the solution. Implementing the cloud computing solution or the AI/ML generated solution may include any other suitable implementation.

The ICO engine may be continually trained using the intelligence base and the resumption log.

The observer engine may continually identify interruptions during execution of the orchestration scripts.

The ICO may include a resumption analyzer engine. The resumption analyzer engine may execute the AI/ML algorithms. The apply input engine may include hardware components, such as a processor. The apply input engine may include software components, such as one or more application code elements and one or more algorithms. The resumption analyzer engine may loop through the resumption log to identify duplicate interruptions and corresponding solutions. The resumption log may store a plurality of interruptions and corresponding solutions over a period of time. The interruptions and corresponding solutions may be from one orchestration script. The interruptions and corresponding solutions may be from a plurality of orchestration scripts.

The resumption analyzer may assign a rank to each interruption and corresponding solution based on a frequency of occurrence for each interruption and corresponding solution. A ranking representing a greater frequency of occurrence may be greater in numeric value than a ranking representing a lesser frequency of occurrence. A greater ranking may indicate a greater frequency of occurrence. A lesser ranking may indicate a lesser frequency of occurrence.

After assigning a rank, the resumption analyzer may delete the duplicate interruptions and corresponding solutions. After the duplicate interruptions and corresponding solutions are deleted, the resumption log may list each individual interruption and corresponding solution and a frequency of occurrence for each interruption and corresponding solution.

The resumption analyzer may include weighing each interruption and corresponding solution. Weighing each interruption and corresponding solution may determine a level of influence each interruption and corresponding solution has when the interruptions and corresponding solutions are used to train the ICO engine and the AI/ML algorithms. An interruption and corresponding solution with a weight that is greater than a threshold weight may have a greater influence on the training of the ICO engine and the AI/ML algorithms. An interruption and corresponding solution with a weight that is less than the threshold weight may have a lesser influence on the training of the ICO engine and the AI/ML algorithms.

Each interruption and corresponding solution may be weighed based on the rank assigned to each interruption and corresponding solution. For example, an interruption and corresponding solution that was assigned a higher ranking (i.e. has a greater frequency of occurrence), may be weighed with a greater weight. An interruption and corresponding solution that was assigned a lower ranking (i.e. has a lesser frequency of occurrence) may be weighed with a lesser weight.

Each interruption and corresponding solution may be weighed based on whether or not the corresponding solution was successful for each interruption. For example, a corresponding solution for an interruption that was determined to be successful over a threshold level of success may be weighed with a greater weight. A corresponding solution for an interruption that was determined to be successful under a threshold level of success may be weighed with a lesser weight.

The ICO engine may be trained using the weighed interruptions and corresponding solutions. Weighing the interruptions and corresponding solutions may enable more accurate and precise decision making and prediction generation.

The apply input engine may be honed based on an effectiveness of a corresponding solution for resolving an interruption. Honing the apply input engine may include improving the accuracy and precision of outputs generated by the apply input engine. Honing the apply input engine may include continually updating and improving the apply input engine. In response to determining an effectiveness of a corresponding solution for resolving an interruption, the interruption and corresponding solution may be used to further train the apply input engine.

The pBFT algorithm may be honed based on an effectiveness of a corresponding solution for resolving an interruption. Honing the pBFT algorithm may include improving the accuracy and precision of the decision-making being executed by the pBFT algorithm. Honing the pBFT algorithm may include continually updating and improving the pBFT algorithm. In response to determining an effectiveness of a corresponding solution for resolving an interruption, the interruption and corresponding solution may be used to further train the pBFT algorithm.

The resumption analyzer engine may generate an intelligence trend. The intelligence trend may identify a pattern of which interruptions occur at level of frequency that is greater than a threshold frequency and which interruptions occur at a level of frequency that is less than a threshold level of frequency. The intelligence trend may be stored in the intelligence base. The intelligence trend may be continually updated. The intelligence trend may be used to train the ICO engine and the AI/ML algorithms.

Illustrative method steps may be combined. For example, an illustrative method may include steps shown in connection with another illustrative method.

The steps of methods may be performed in an order other than the order shown or described herein. Embodiments may omit steps shown or described in connection with illustrative methods. Embodiments may include steps that are neither shown nor described in connection with illustrative methods.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

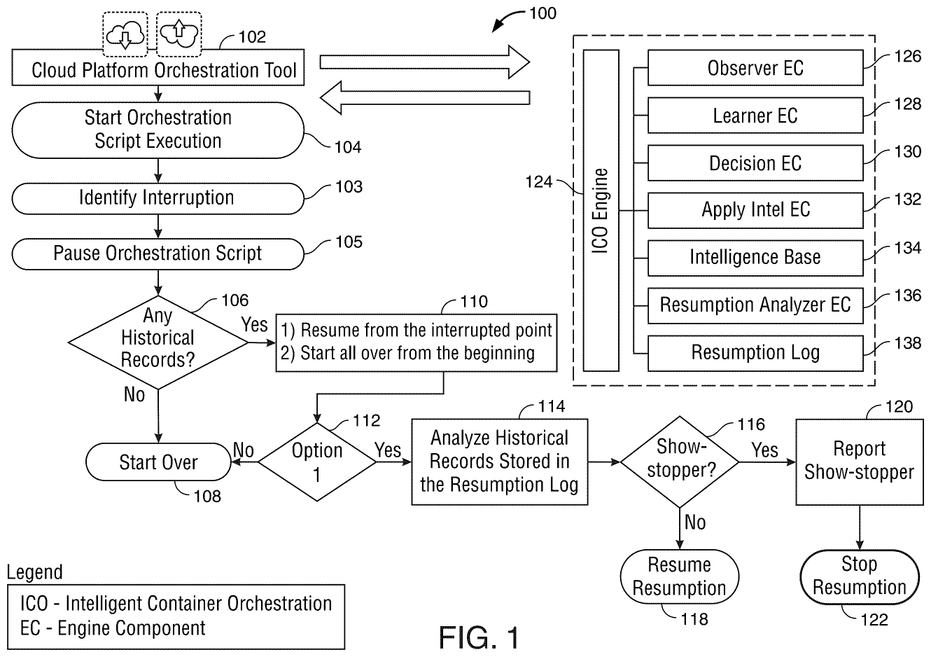

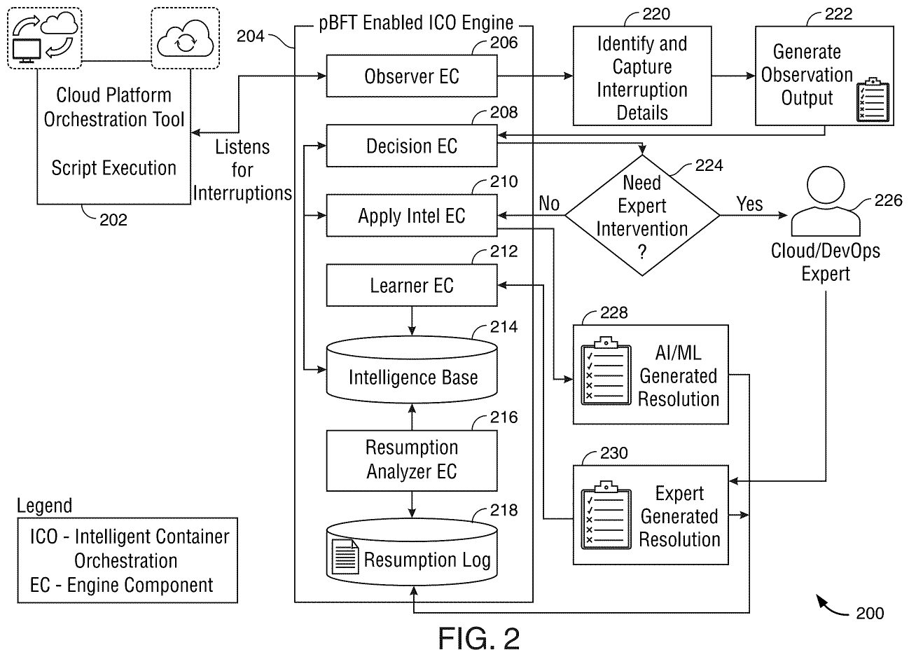

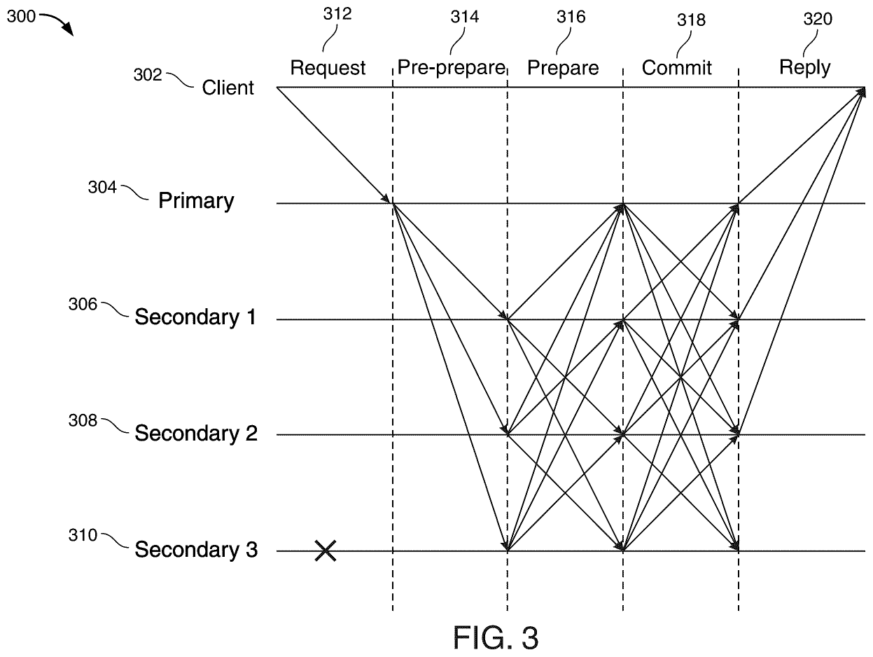

FIG. 1 shows cloud computing interruption identification process 100. ICO engine 124 may monitor cloud computing orchestration tool 102. ICO engine 124 may include observer EC 126, learner EC 128, decision EC 130, intel EC 132, intelligence base 134, resumption analyzer EC 136 and resumption log 138. Illustrative engine components, observer EC 126, learner EC 128, decision EC 130, apply intel EC 132, intelligence base 134, resumption analyzer EC 136 and resumption log 138 may be further described in FIG. 2.

At step 104, cloud computing orchestration tool 102 may execute an orchestration script. At step 103, observer EC 126 may identify an interruption in the orchestration script. In response to identifying an interruption in the orchestration script, ICO engine 124 may pause the orchestration script at step 105. At step 106, decision EC 130 may determine if there is any historical data relating to the interruption stored in resumption log 138 or intelligence base 134. In response to determining that there is no historical data relating to the interruption stored in resumption log 138 or intelligence base 134, step 108 may include restarting the orchestration script.

In response to determining that there is historical data related to the interruption stored in resumption log 138 or intelligence base 134, step 110 may include determining whether to resume the orchestration script from the point of interruption or to start the orchestration script from an initial starting point.

In response to determining to resume the orchestration script from the point of interruption at step 112, step 114 may include analyzing the historical records via resumption analyzer EC 136. Based on the analyzation of the historical records, step 116 may include determining whether the interruption is a show-stopper. In response to determining that the interruption is a show-stopper in step 120, step 122 may stop the resumption. In response to determining that the interruption is not a show-stopper, step 118 may include initiating the resumption. A show-stopper may include an interruption that can not be resolved. A show-stopper may include an interruption that, when resolved, causes the orchestration script to restart from the initial starting point. A show stopper may include any suitable interruption that prevents resuming the orchestration script from the point of interruption.

FIG. 2 shows cloud computing interruption identification process 200. Cloud computing interruption identification process 200 may have one or more features in common with cloud computing interruption identification process 100.

Cloud platform orchestration tool 202 may execute a script. The script may be an orchestration script. The orchestration script may execute automated cloud computing functions.

Cloud platform orchestration tool 202 may be in electronic communication with practical byzantine fault tolerance “pBFT” enabled ICO engine 204. PBFT enable ICO engine 204 may include observer EC 206. PBFT enable ICO engine 204 may include decision EC 208. PBFT enable ICO engine 204 may include apply intel EC 210. PBFT enable ICO engine 204 may include learner EC 212. PBFT enable ICO engine 204 may include intelligence base 214. PBFT enable ICO engine 204 may include resumption analyzer EC 216. PBFT enable ICO engine 204 may include resumption log 218. PBFT enable ICO engine 204 may include any other suitable component.

Observer EC 206 may monitor the orchestration script. At step 220, observer EC 206 may identify and capture an interruption in the orchestration script. At step 222, Observer EC 206 may generate an observation output. The observation output may include details relating to the interruption. The observation output may be transmitted to decision EC 208.

At step 224, decision EC 208 may determine whether the interruption requires expert intervention or AI/ML intervention. In response to determining that the interruption requires expert intervention in order to resolve the interruption, step 226 may include transmitting the observation output to a cloud/DevOps expert. The cloud/DevOps expert may resolve the interruption. At step 230, the expert generated resolution may be transmitted to learner EC 212 to be analyzed and stored in intelligence base 214. At the same time, step 230 may include storing the expert generated solution in resumption log 218.

In response to determining that interruption can be resolved via AI/ML, step 228 may include using apply intel EC 210 to generate a resolution to the interruption via AI/ML. Apply intel EC 210 may be trained using analyses stored in intelligence base 214. The AI/ML generated resolution may be stored in resumption log 218.

Resumption log analyzer EC 216 may analyze resumption log 218. Resumption log analyzer EC 216 may identify patterns and trends of interruptions and corresponding solutions within resumption log 218. Resumption log analyzer EC 216 may improve the training of pBFT enabled ICO engine 204 based on the identified patterns and trends.

FIG. 3 shows pBFT consensus process 300. In request phase 312, client 302 may generate a request. Client 302 may transmit the request to primary node 304. In pre-prepare phase 314, primary node 304 may propagate the request to a group of decisioning nodes. Primary node 304 may propagate the request to secondary node 306, secondary node 308, secondary node 310 and any other secondary node included in the group of decisioning nodes.

In prepare phase 316, every node that received the request may broadcast a prepare message to all other nodes that it received the request and is ready to commit to a response to the request. In commit phase 318, each nodes broadcasts a commit message indicating that it has reached a consensus. Each node may only broadcast a commit message after receiving prepare messages from at least a two-thirds majority of nodes. In reply phase 320, each node may transmit a reply message, including the reply to the request to client 302.

Secondary node 310 may be a faulty or malicious node. Secondary node 310 may not transmit a reply to client 302. Client 302 may determine a solution to the request based on a consensus from a majority of the nodes and therefore, client 302 may determine a solution to the request without receiving a commit message from secondary node 310. As such, secondary node 310 may not affect the solution to the request.

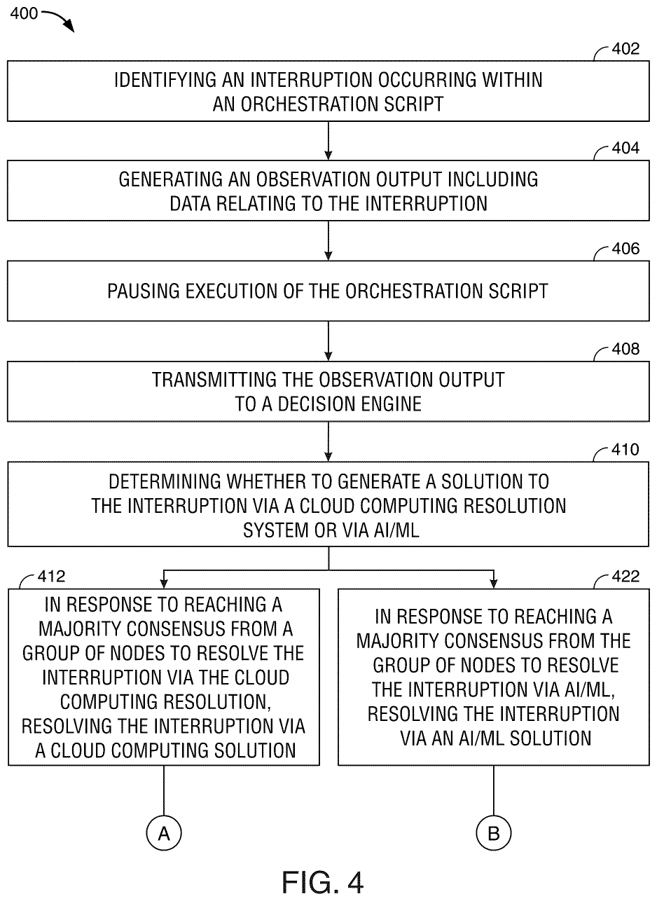

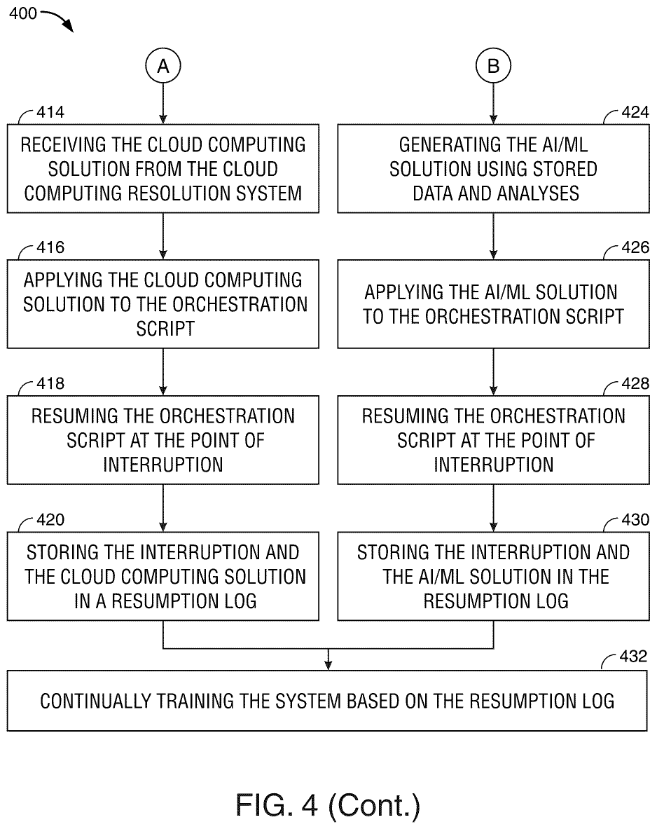

FIG. 4 shows interruption process resumption 400. Step 402 may include identifying an interruption occurring within an orchestration script. Step 404 may include generating an observation output including data relating to the interruption. The orchestration script may be paused at step 406. At step 408, the observation output may be transmitted to a decision engine. The decision engine may determine whether to generate a solution to the interruption via a cloud computing resolution or via AI/ML at step 410.

In response to reaching a majority consensus from a group of nodes to resolve the interruption via the cloud computing resolution, step 412 may include resolving the interruption via a cloud computing solution. At step 414, the cloud computing solution may be received from the cloud computing system. At step 416 the cloud computing solution may be applied to the orchestration script. The orchestration script may be resumed from the point of interruption at step 418. At step 420, the interruption and the cloud computing solution may be stored in the resumption log.

In response to reaching a majority consensus from the group of nodes to resolve the interruption via AI/ML, step 422 may include resolving the interruption via an AI/ML solution. At step 424, the AI/ML solution may be generated using stored data and analyses. At step 426, the AI/ML solution may be applied to orchestration script. The orchestration script may be resumed from the point of interruption at step 428. At step 430, the interruption and the AI/ML solution may be stored in the resumption log.

At step 432, the ICO engine may be continually trained based on the resumption log.

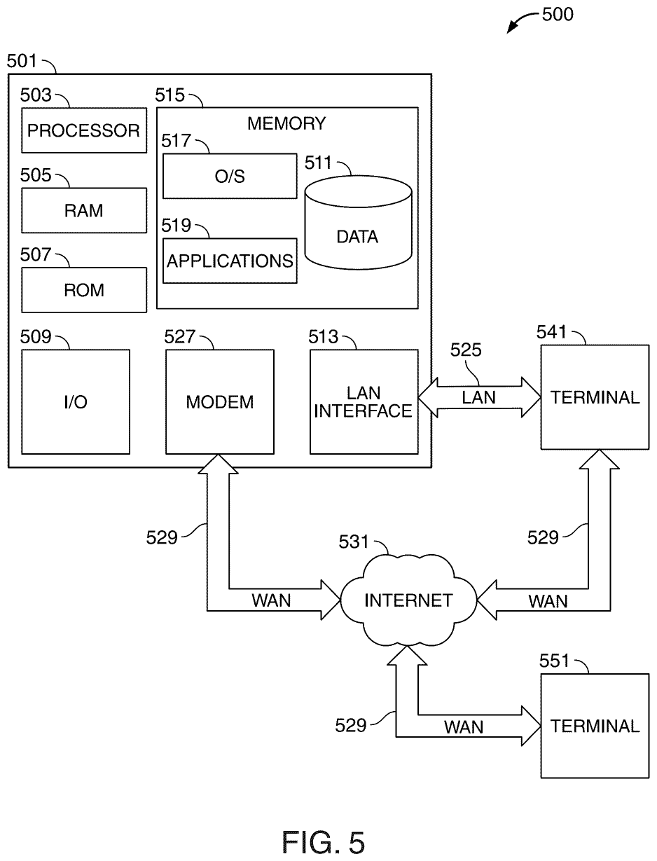

FIG. 5 shows an illustrative block diagram of system 500 that includes computer 501. Computer 501 may alternatively be referred to herein as an “engine,” “server,” or a “computing device.” Computer 501 may be a workstation, desktop, laptop, tablet, smartphone and/or any other suitable computing device. Elements of system 500, including computer 501, may be used to implement various aspects of the systems and methods disclosed herein. Each of the systems, methods and algorithms illustrated above/below may include some or all of the elements and apparatus of system 500.

Computer 501 may include processor 503 for controlling the operation of the device and its associated components, and may include RAM 505, ROM 507, input/output (“I/O”) 509, and a non-transitory or non-volatile memory 515. Machine-readable memory may be configured to store information in machine-readable data structures. Processor 503 may also execute software running on the computer. Other components commonly used for computers, such as EEPROM or flash memory or any other suitable components, may also be part of computer 501.

Memory 515 may include any suitable permanent storage technology, such as a hard drive. Memory 515 may store software including the operating system 517 and application program(s) 519 together with any data 511 needed for the operation of the system 500. Memory 515 may also store videos, text and/or audio assistance files. The data stored in memory 515 may also be stored in cache memory and/or any other suitable memory.

I/O module 509 may include connectivity to a microphone, keyboard, touch screen, mouse and/or stylus through which input may be provided into computer 501. The input may include input relating to cursor movement. The input/output module may also include one or more speakers for providing audio output and a video display device for providing textual, audio, audiovisual and/or graphical output. The input and output may be related to computer application functionality.

System 500 may be connected to other systems via a local area network (“LAN”) interface 513. System 500 may operate in a networked environment supporting connections to one or more remote computers, such as terminals 541 and 551. Terminals 541 and 551 may be personal computers or servers that include many or all of the elements described above relative to system 500. The network connections depicted in FIG. 5 include LAN 525 and a wide area network (“WAN”) 529 but may also include other networks. When used in a LAN networking environment, computer 501 may connect to LAN 525 through LAN interface 513 or an adapter. When used in a WAN networking environment, computer 501 may include modem 527 or other means for establishing communications over WAN 529, such as Internet 531.

It will be appreciated if the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (“API”). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory and/or any other suitable memory.

Additionally, application program(s) 519, which may be used by computer 501, may include computer executable instructions for invoking functionality related to communication, such as e-mail, Short Message Service (“SMS”), and voice input and speech recognition applications. Application program(s) 519 (which may be alternatively referred to herein as “plugins,” “applications,” or “apps”) may include computer executable instructions for invoking functionality related to performing various tasks. Application program(s) 519 may utilize one or more algorithms that process received executable instructions, perform power management routines or other suitable tasks.

The invention may be described in the context of computer-executable instructions, such as application(s) 519, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered for the purposes of this application, as engines with respect to the performance of the particular tasks to which the programs are assigned.

Computer 501 and/or terminals 541 and 551 may also include various other components, such as a battery, speaker and/or antennas (not shown). Components of computer 501 may be linked by a system bus, wirelessly or by other suitable interconnections. Components of computer 501 may be present on one or more circuit boards. In some embodiments, the components may be integrated into a single chip. The chip may be silicon-based.

Terminal 541 and/or terminal 551 may be portable devices such as a laptop, cell phone, tablet, smartphone or any other computing system for receiving, storing, transmitting and/or displaying relevant information. Terminal 541 and/or terminal 551 may be one or more user devices. Terminals 541 and 551 may be identical to system 500 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

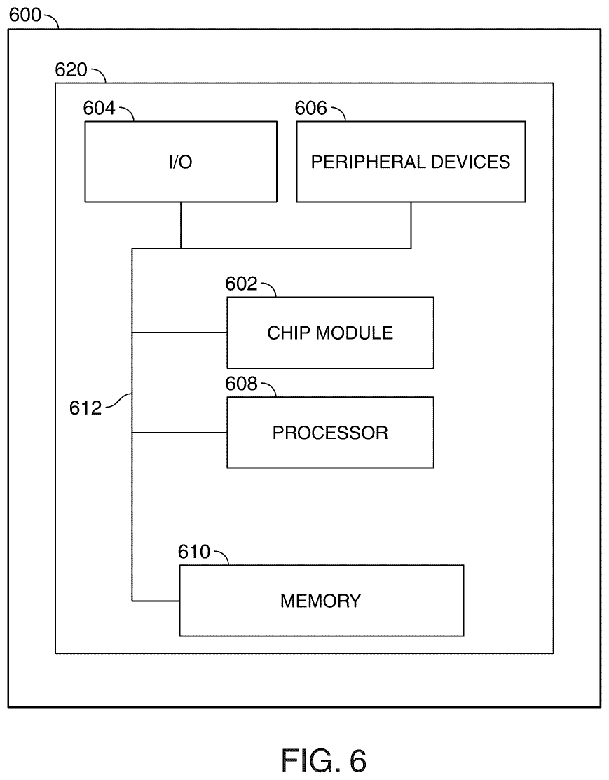

FIG. 6 shows illustrative apparatus 600 that may be configured in accordance with the principles of the disclosure. Apparatus 600 may be a computing device. Apparatus 600 may include one or more features of the apparatus shown in FIG. 5. Apparatus 600 may include chip module 602, which may include one or more integrated circuits, and which may include logic configured to perform any suitable logical operations.

Apparatus 600 may include one or more of the following components: I/O circuitry 604, which may include a transmitter device and a receiver device and may interface with fiber optic cable, coaxial cable, telephone lines, wireless devices, PHY layer hardware, a keypad/display control device or any other suitable media or devices; peripheral devices 606, which may include counter timers, real-time timers, power-on reset generators or any other suitable peripheral devices; logical processing device 608, which may compute data structural information and structural parameters of the data; and machine-readable memory 610.

Machine-readable memory 610 may be configured to store in machine-readable data structures: machine executable instructions, (which may be alternatively referred to herein as “computer instructions” or “computer code”), applications such as applications 519, signals, and/or any other suitable information or data structures.

Components 602, 604, 606, 608, and 610 may be coupled together by a system bus or other interconnections 612 and may be present on one or more circuit boards such as circuit board 620. In some embodiments, the components may be integrated into a single chip. The chip may be silicon-based.

As will be appreciated by one of ordinary skill in the art, the present invention may be embodied as an apparatus (including, for example, a system, a machine, a device, a computer program product, and/or the like), as a method (including, for example, a process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with intelligently controlling data transfers between network connected devices and a platform layer application server.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for intelligently controlling data transfers between network connected devices and a platform layer application server, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

In some aspects of the described methods and systems, a regulated machine learning (ML) model is utilized. The regulated ML model is designed to make incremental learning adjustments in tandem with the determinations made by the machine learning engine and communicated to the regulated ML model. The machine learning engine accesses data outputted from storage of previous datasets, and it is trained to use data from the incoming dataset to collectively formulate and approve incremental learning adjustments with the regulated ML model. The regulated ML model and the machine learning engine may consider input data patterns, output data patterns, thresholds for model performance, and/or distributions of identified patterns between different ML models.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, methods and apparatus for a PRACTICAL BYZANTINE FAULT TOLERANCE (“PBFT”) ENABLED INTELLIGENT CONTAINER ORCHESTRATION (“ICO”) ENGINE are provided. Persons skilled in the art will appreciate that the present disclosure can be practiced by other than the described embodiments, which are presented for purposes of illustration rather than of limitation and that the present disclosure is limited only by the claims that follow.

What is claimed is:

1. A method for identifying interruptions occurring within orchestration scripts that are executing to deploy containers in a cloud computing platform and determining solutions for identified interruptions, the method using an intelligent container orchestration (“ICO”) engine, the method comprising:
identifying an interruption at an observer engine, the interruption occurring within an orchestration script, the identifying comprising:
capturing a screen recording of the orchestration script;
detecting, from the screen recording, a point of interruption within the orchestration script, the point of interruption including:
an orchestration script name;
a line number in which the interruption is identified; and
a date and time when the interruption occurred; and
generating an observation output including data relating to the point of interruption;
in response to identifying the interruption, pausing execution of the orchestration script;
transmitting the observation output to a decision engine, the decision engine executing a practical byzantine fault tolerance (“pBFT”) algorithm, the pBFT algorithm configured to make a decision based on a majority consensus;
analyzing, at the decision engine, whether to determine a solution to the interruption via a cloud computing resolution system or via artificial intelligence (“AI”)/ machine learning (“ML”);
in response to reaching a majority consensus from a group of nodes included in the ICO to resolve the interruption via the cloud computing resolution, resolving the interruption via a cloud computing solution, the resolving comprising:
electronically transmitting the observation output to the cloud computing resolution system;
electronically receiving the cloud computing solution from the cloud computing resolution system;
implementing the cloud computing solution with the orchestration script;
resuming the orchestration script at the point of interruption;
in parallel with implementing the cloud computing solution to the orchestration script, transmitting the cloud computing solution to a learner engine, the learner engine configured to generate an analysis of the cloud computing solution and store the analysis in an intelligence base; and
storing the interruption and the cloud computing solution in a resumption log;
in response to reaching a majority consensus from the group of nodes included in the ICO to resolve the interruption via AI/ML, resolving the interruption via an AI/ML solution, the resolving including:
transmitting the observation output to an apply input engine;
generating the AI/ML solution using data and analyses stored in the intelligence base;
implementing the AI/ML solution with the orchestration script;
resuming the orchestration script at the point of interruption; and
storing the interruption and the AI/ML solution in the resumption log; and
continually training the ICO engine using the intelligence base and the resumption log.

2. The method of claim 1 further comprising using the ICO to continually identify interruptions during execution of the orchestration scripts.

3. The method of claim 2 further comprising:
looping through the resumption log to identify duplicate interruptions and corresponding solutions;
assigning a rank to each interruption and corresponding solution based on a frequency of occurrence for each interruption and corresponding solution; and
deleting the duplicate interruptions and corresponding solutions.

4. The method of claim 3 further including:
weighing each interruption and corresponding solution based on:
the rank assigned to each interruption and corresponding solution; and
whether or not the corresponding solution was successful for each interruption; and
training the ICO engine using the weighted interruptions and corresponding solutions.

5. The method of claim 2 further including honing the apply input engine based on an effectiveness of a corresponding solution for resolving an interruption.

6. The method of claim 2 further including honing the pBFT algorithm based on an effectiveness of a corresponding solution for resolving an interruption.

7. The method of claim 2 further comprising using a resumption analyzer engine to generate an intelligence trend, the intelligence trend identifying a pattern of:
which interruptions occur at level of frequency that is greater than a threshold frequency; and
which interruptions occur at a level of frequency that is less than a threshold level of frequency.

8. Apparatus for identifying interruptions occurring within orchestration scripts that are executing to deploy containers in a cloud computing platform and determine solutions for identified interruptions, the apparatus comprising an intelligent container orchestration (“ICO”) engine, the ICO engine comprising:
an observer engine configured to identify an interruption occurring within an orchestration script, the observer engine configured to:
capture a screen recording of the orchestration script;
detect, from the screen recording, a point of interruption within the orchestration script, the point of interruption including:
an orchestration script name;
a line number in which the interruption is identified; and
a date and time when the interruption occurred; and
generate an observation output including data relating to the point of interruption;
an intelligence base including memory configured to store the screen recording of the orchestration script;
an orchestration script pause engine configured to pause execution of the orchestration script;
a decision engine including a plurality of decisioning nodes that are configured to execute AI algorithms and to be trained with data from the intelligence base, the decision engine being configured to execute a practical byzantine fault tolerance (“pBFT”) algorithm that is configured to make a decision based on a majority consensus from the plurality of decisioning nodes, the decision engine configured to:
receive the observation output from the observer engine in response to a pausing of the orchestration script by the orchestration script pause engine; and
determine, using the decisioning nodes, whether to generate a solution to the interruption via a cloud computing resolution system or via artificial intelligence (“AI”)/machine learning (“ML”);
the cloud computing system configured to resolve the interruption via a cloud computing resolution in response to a majority consensus from the plurality of decisioning nodes to resolve interruption via the cloud computing system;
a learner engine configured to execute AI algorithms, the learner engine configured to generate an analysis of the cloud computing solution and store the analysis in the intelligence base;
a resumption log configured to store the interruption and the cloud computing solution; and
an apply input engine configured to execute AI algorithms, the apply input engine configured to:
resolve the interruption via an AI/ML solution in response to a majority consensus from the plurality of decisioning nodes to resolve the interruption via AI/ML by using data and analyses stored in the intelligence base; and
store the interruption and the AI/ML solution in the resumption log;
wherein the ICO engine is configured to be continually trained using the intelligence base and the resumption log.

9. The apparatus of claim 8 wherein the observer engine is further configured to continually identify interruptions during execution of the orchestration scripts.

10. The apparatus of claim 9 further comprising a resumption analyzer engine configured to:
loop through the resumption log to identify duplicate interruptions and corresponding solutions;
assign a rank to each interruption and corresponding solution based on a frequency of occurrence for each interruption and corresponding solution; and
delete the duplicate interruptions and corresponding solutions.

11. The apparatus of claim 10 wherein the resumption analyzer engine is further configured to:
weigh each interruption and corresponding solution based on:
the rank assigned to each interruption and corresponding solution; and
whether or not the corresponding solution was successful for each interruption; and
train the ICO engine using the weighted interruptions and corresponding solutions.

12. The apparatus of claim 9 wherein the apply input engine is configured to be honed based on an effectiveness of each solution for resolving the corresponding interruption.

13. The apparatus of claim 9 wherein the pBFT algorithm is configured to be honed based on an effectiveness of each solution for resolving the corresponding interruption.

14. The apparatus of claim 10 wherein the resumption analyzer engine is further configured to generate an intelligence trend, the intelligence trend identifying a pattern of:
which interruptions occur at level of frequency that is greater than a threshold frequency; and
which interruptions occur at a level of frequency that is less than a threshold level of frequency.

15. Apparatus for identifying interruptions occurring within orchestration scripts that are executing to deploy containers in a cloud computing platform and determine solutions for identified interruptions, the apparatus comprising an intelligent container orchestration (“ICO”) engine, the ICO engine configured to:
capture a screen recording of an orchestration script;
identify an interruption occurring within the orchestration script;
detect, from the screen recording, a point of the interruption within the orchestration script, the point of the interruption including:
an orchestration script name;
a line number in which the interruption is identified; and
a date and time when the interruption occurred; and
generate an observation output including data relating to the point of the interruption;
store the screen recording of the orchestration script in an intelligence base;
execute a practical byzantine fault tolerance (“pBFT”) algorithm that is configured to make a decision based on a majority consensus from a plurality of decisioning nodes that are configured to execute AI algorithms and to be trained with data from the intelligence base;
pause the orchestration script using an orchestration script pause engine;
determine, using the decisioning nodes, whether to generate a solution to the interruption via a cloud computing resolution system or via artificial intelligence (“AI”)/machine learning (“ML”);
resolve the interruption via a cloud computing resolution in response to a majority consensus from the plurality of decisioning nodes to resolve interruption via the cloud computing system;
generate an analysis of the cloud computing solution and store the analysis in the intelligence base;
store the interruption and the cloud computing solution in a resumption log;
resolve the interruption via an AI/ML solution in response to a majority consensus from the plurality of decisioning nodes to resolve the interruption via AI/ML by using data and analyses stored in the intelligence base; and
store the interruption and the AI/ML solution in the resumption log;
wherein the ICO engine is configured to be continually trained using the intelligence base and the resumption log.

16. The apparatus of claim 15 wherein the ICO engine is further configured to continually identify interruptions during execution of the orchestration scripts.

17. The apparatus of claim 16 wherein the ICO engine is further configured to:
loop through the resumption log to identify duplicate interruptions and corresponding solutions;
assign a rank to each interruption and corresponding solution based on a frequency of occurrence for each interruption and corresponding solution; and
delete the duplicate interruptions and corresponding solutions.

18. The apparatus of claim 17 wherein the ICO engine is further configured to:
weigh each interruption and corresponding solution based on:
the rank assigned to each interruption and corresponding solution; and
whether or not the corresponding solution was successful for each interruption; and
be trained using the weighted interruptions and corresponding solutions.

19. The apparatus of claim 16 wherein the pBFT algorithm is configured to be honed based on an effectiveness of each solution for resolving the corresponding interruption.

20. The apparatus of claim 16 wherein the ICO is further configured to generate an intelligence trend, the intelligence trend identifying a pattern of:
which interruptions occur at level of frequency that is greater than a threshold frequency; and
which interruptions occur at a level of frequency that is less than a threshold level of frequency.
